(19) United States
(12) Patent Application Publication
(10) Pub. No.: US 2004/0141792 A1
(43) Pub. Date: Jul. 22, 2004

(54) Output media handling

(76) Inventors: Richard Lee Brinkly, Vancouver, WA (US); Jeffery Scott Mathena, Vancouver, WA (US)

Correspondence Address: HEWLETT-PACKARD COMPANY, Intellectual Property Administration, P.O. Box 272400, Fort Collins, CO, 80527-2400, US

(21) Appl. No.: 10/345,564

(22) Filed: Jan. 16, 2003

(51) Int. Cl. B41J 11/58

(52) U.S. Cl. 400/706

(57) ABSTRACT

An implementation of a technology for providing a physical offset between print jobs on a printing device is described herein.

### BACKGROUND

In a conventional printing scenario, it is typical for each successive print job to accumulate in a pile of indistinguishable paper in a common output collection tray. Since there is no readily apparent indication distinguishing one print job from another, the time-consuming and error-prone chore of sorting and separating multiple print jobs found in the pile is typically left to humans. Typically, the human is one in search of his own print job and caring much less about sorting and separating other print jobs found in the pile.

To provide a readily apparent print-job distinguishing indication, many conventional techniques have been employed. Examples of such include:

Separator Page: automatically inserting a separator page between print jobs (often this page is colored and has an identifying banner or header);

Moving Tray: physically moving the entire output collection tray from side to side to physically offset one print job from the next;

Moving Feeder: physically moving the output feed mechanism from side to side to physically offset one print job from the next; and

Forcing Moving Output: forcing the paper from side to side with a edge-loading roller or guide to physically offset one print job from the next.

In addition to requiring time-consuming manual physical separation of print jobs, the major drawback to the use of a “separator page” is waste. The extra paper used to separate print jobs is often considered undesirable for economic and ecologic reasons.

The other three conventional techniques require additional motors, electronic controllers, and/or mechanisms (e.g., to move a mechanical device from one side to the other). This is usually adds more cost and complexity.

Furthermore, the “forcing moving output” approach applies force the edge of the printed media while it is moving. For some delicate media, this approach has the potential to damage the media. This approach can also cause the media to jam in the output feed mechanism.

### SUMMARY

Described herein is a technology for providing a physical offset between print jobs on a printing device. Using an embodiment of a print media biasing mechanism, described herein, a printer alternatively collects the print media of print jobs in stacks biased to one side or the other of an output collection tray.

### BRIEF DESCRIPTION OF THE DRAWINGS

The same numbers are used throughout the drawings to reference like elements and features.

FIG. 1 illustrates a typical printer.

FIG. 2 illustrates a printer having an embodiment according to an implementation described herein.

FIG. 3 is a flow diagram showing a methodological implementation described herein.

FIG. 4 is a printing device in accordance with an implementation described herein.

### DETAILED DESCRIPTION

The following description sets forth one or more exemplary implementations of an output media handling. The inventors intend these exemplary implementations to be examples. The inventors do not intend these exemplary implementations to limit the scope of the claimed present invention. Rather, the inventors have contemplated that the claimed present invention might also be embodied and implemented in other ways, in conjunction with other present or future technologies.

An example of an embodiment of an output media handling may be referred to as an “exemplary output media handler.”

### Introduction

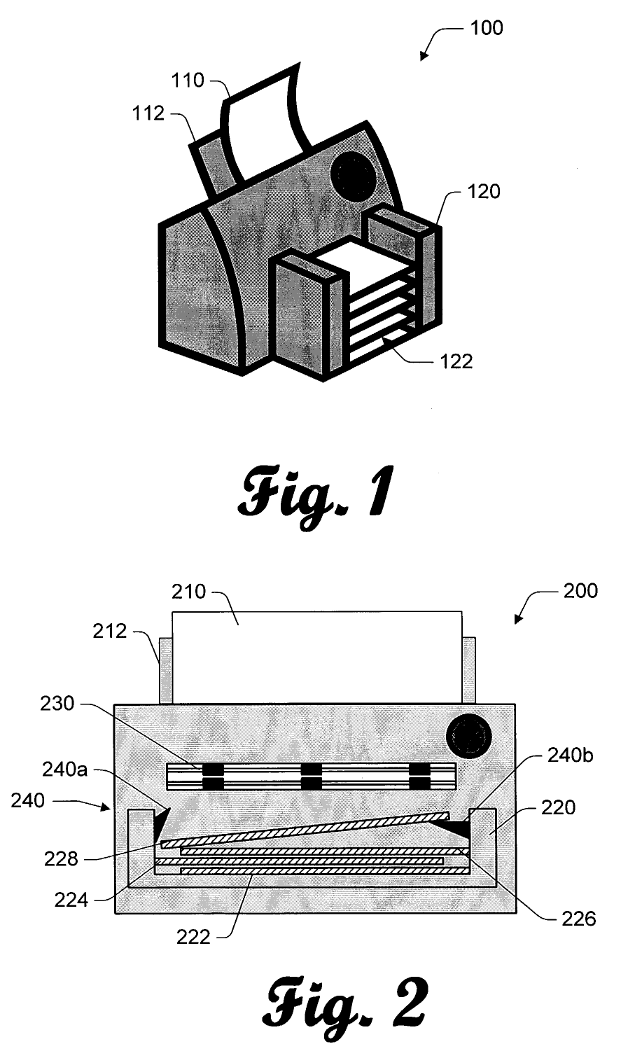

FIG. 1 shows a typical printer 100. In printer 100, print media 110 (e.g., paper) is directed through a print cycle which includes picking a media sheet from an input tray 112, transporting the media sheet through a printing zone (not shown) for printing, and then transporting the printed sheet through an output port (not shown in FIG. 1).

Once the printed sheet exits the output port, an output tray 120 often receives the printed sheet. Consecutive printed sheets are piled one on top of another as successive sheets are printed to form an output stack 122

In an effort to address various issues (e.g., ink drying time), some printers employ an active sheet media delivery mechanism. With such, a printed sheet is guided along a pair of movable rails (not shown in FIG. 1), which temporarily support the sheet above the printer's output tray while the previously printed sheet dries. Once printing is completed, the rails retract (often pivotally) allowing the sheet to fall to an output tray below. These rails are often called “wings.”

To prevent skewing and promote even stacking of the output, such active sheet media delivery mechanisms are driven cyclically by the same drive that drives the paper feed. For example, the wings typically pivot together so that the sheet falls evenly onto the output tray, thereby forming an even and unskewed output stack.

### Exemplary Output Media Handler

The one or more exemplary implementations, described herein, of the exemplary output media handler may be implemented (in whole or in part) by a printer 200.

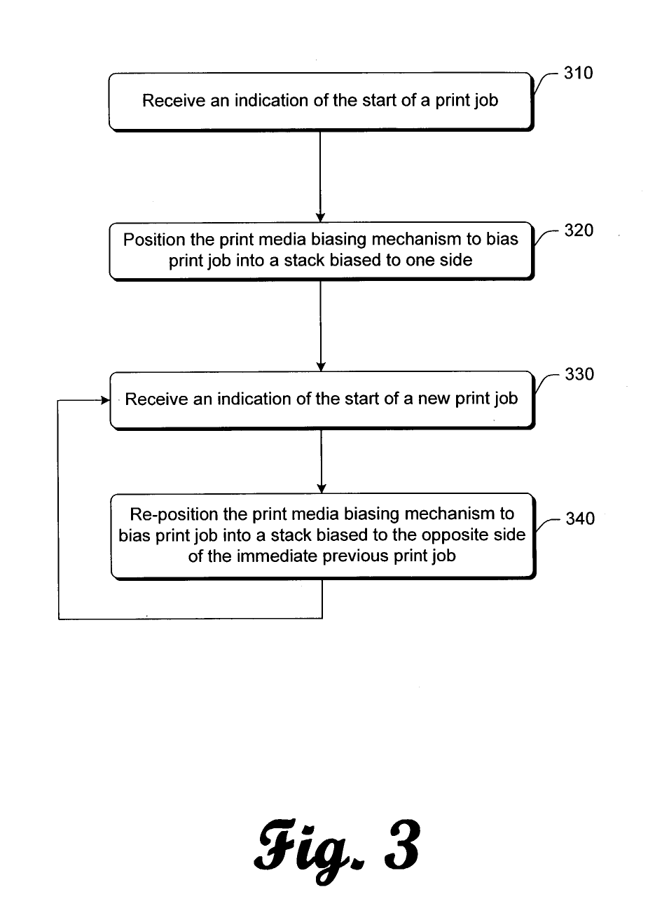

FIG. 2 shows the printer 200, for which print media 210 (e.g., paper) is directed through a print cycle, like printer 100. That print cycle includes picking a media sheet from an input tray 212, transporting the media sheet through a printing zone (not shown) for printing, and then transporting the printed sheet through an output port 230. Once the printed sheet exits the output port, a stationary output collection tray 220 often receives the printed sheet. However, unlike the printer 100, consecutive printed sheets do not simply pile evenly one on top of another as successive sheets are printed.

The printer 200 employs a print media handling mechanism 240 with a pair of movable rails, 240a and 240b. These rails are also called “wings.” Once printing is completed, the wings retract, often pivotally, allowing the sheet to fall to an output tray below.

However, unlike the wings of the printer 100, the movement of each of wings of the printer 200 may be independent controlled. These wings independently move (e.g., pivot) in coordination to effectively and purposefully skew the print media of print jobs in an alternating fashion. An example of the result of this is illustrated by print jobs 222, 224, 226, and 228 in FIG. 2.

The independently controlled wings, 240a and 240b, are applied to the output feed media, directly above the output collection tray 220. These wings are used to support the paper above the output tray while the printer 200 is feeding printed media by the output feed mechanism 230.

After the media is fully past the output feed mechanism 230 and no longer in contact with the mechanism, one wing (e.g., 240a) is retracted and withdrawn from contact with the media. This allows one edge of the media to drop towards one side of the output collection tray 220. However, the opposing wing (e.g., 240b) is still in an extended position, supporting a different edge of the media. In this position, the media is biased towards one side of the output collection tray.

In a subsequent operation, the extended wing (e.g., 240b) is retracted, allowing the suspended edge of the media to also fall into the output collection tray 220. The result is the media is now resting in the output collection tray and is strongly biased (or skewed) to one side of the tray.

This same operation sequence is repeated until the print job is completed and all pages are collected in the output collection tray. All pages of the similar print job are strongly biased and stacked on the same side of the output collection tray

Upon additional print jobs being printed, the sequence of wing retraction is reversed. In other words, the wing that was retracted for the prior print job is now extended to suspend an edge of the media for this print job while the wing that was extended for the prior print job is now retracted. This reversed sequence is repeated until the print job is completed and no further pages are ejected from the print device.

The result is a second stack of media, resting directly upon the first print job stack, strongly biased to the opposite side of the output collection tray. This is illustrated as stack 224 in FIG. 2.

This procedure may be repeated for any additional print jobs. These additional print jobs would be stacked and strongly biased against alternatingly opposite sides of the output collection tray 220 as compared with the immediately preceding print job. This is illustrated by stacks 222, 224, 226, and 228 in FIG. 2.

As compared to conventional approaches, the exemplary output media handler significantly reduces the complexity of the system required to provide and offset output. Furthermore, the overall reliability of the exemplary output media handler is greater that the more complex and conventional alternatives.

Although the exemplary output media handler is described in the context of computer printers (such as laser and ink-jet printers), it may be implemented in other single sheet printing devices, such as copiers, facsimile machines, high-capacity printers, and such.

Furthermore, the printer 200 has been described herein employing independently controlled wings to effectively implement (in whole or in part) the exemplary output media handler. Those of skill in the art, of course, understand and appreciate that other mechanisms may be employed to produces the same or equivalent print media handling described herein. Herein, the term “print media biasing mechanism” encompasses those other print handling mechanisms that are the same as or similar to the wings, 240a and 240b, described herein.

### Methodological Implementation of the Exemplary Output Media Handler

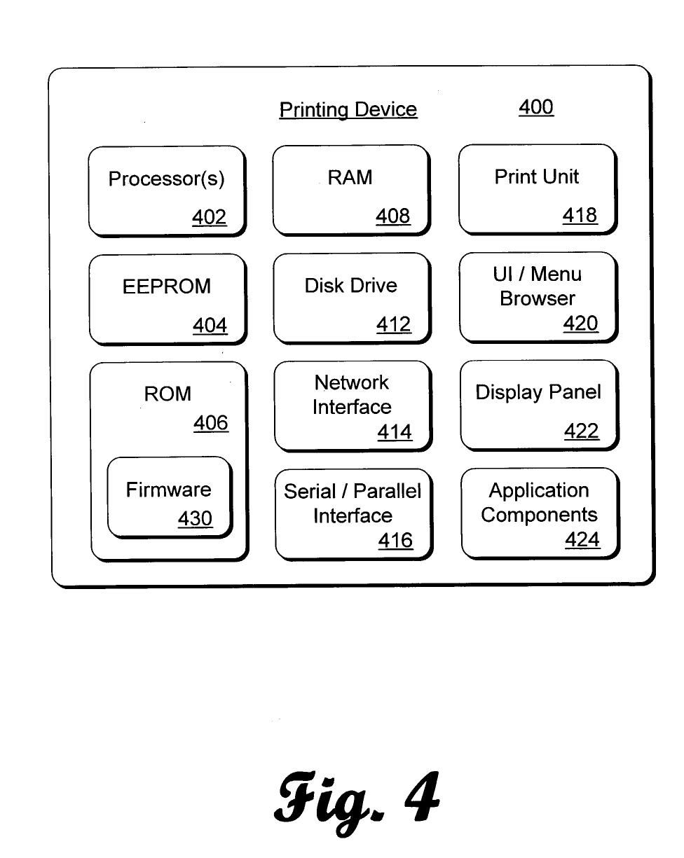

FIG. 3 shows methodological implementation of the exemplary output media handler performed by the printer 200 (or some portion thereof). This methodological implementation may be performed in hardware or a combination of hardware and software.

At 310 of FIG. 3, the printer 200 receives an indication of the start of a print job. Print job differentiation is known to those of skill in the art.

At 320, the printer 200 positions the print media biasing mechanism so that all of the subsequently outputted print media of this present print job are biased towards one side of the output tray 220.

At 330, it receives an indication of another print job.

At 340, it re-positions the print media biasing mechanism so that all of the subsequently output print media of this new print job are biased toward one side of the output tray 220 and that one side is the opposite side from the immediately previous print job.

The printer 200 goes back to block 330 and repeats block 330 and 340 so that the print media of each print job forms its own stack bias to a side opposite of the immediately previous print job. An example of this is illustrated by stacks 222, 224, 226, and 228 in FIG. 2.

### Exemplary Printer Architecture

FIG. 4 illustrates various components of an exemplary printing device 400, which, like printer 200, may be utilized to implement the inventive techniques described herein.

Printer 400 includes one or more processors 402, an electrically erasable programmable read-only memory (EEPROM) 404, ROM 406 (non-erasable), and a random access memory (RAM) 408. Although printer 400 is illustrated having an EEPROM 404 and ROM 406, a particular printer may only include one of the memory components. Additionally, although not shown, a system bus typically connects the various components within the printing device 400.

The printer 400 also has a firmware component 410 that is implemented as a permanent memory module stored on ROM 406. The firmware 410 is programmed and tested like software, and is distributed with the printer 400. The firmware 410 can be implemented to coordinate operations of the hardware within printer 400 and contains programming constructs used to perform such operations.

Processor(s) 402 process various instructions to control the operation of the printer 400 and to communicate with other electronic and computing devices. The memory components, EEPROM 404, ROM 406, and RAM 408, store various information and/or data such as configuration information, fonts, templates, data being printed, and menu structure information. Although not shown, a particular printer can also include a flash memory device in place of or in addition to EEPROM 404 and ROM 406.

Printer 400 also includes a disk drive 412, a network interface 414, and a serial/parallel interface 416. Disk drive 412 provides additional storage for data being printed or other information maintained by the printer 400. Although printer 400 is illustrated having both RAM 408 and a disk drive 412, a particular printer may include either RAM 408 or disk drive 412, depending on the storage needs of the printer. For example, an inexpensive printer may include a small amount of RAM 408 and no disk drive 412, thereby reducing the manufacturing cost of the printer.

Network interface 414 provides a connection between printer 400 and a data communication network. The network interface 414 allows devices coupled to a common data communication network to send print jobs, menu data, and other information to printer 400 via the network. Similarly, serial/parallel interface 416 provides a data communication path directly between printer 400 and another electronic or computing device. Although printer 400 is illustrated having a network interface 414 and serial/parallel interface 416, a particular printer may only include one interface component.

Printer 400 also includes a print unit 418 that includes mechanisms arranged to selectively apply ink (e.g., liquid ink, toner, etc.) to a print media such as paper, plastic, fabric, and the like in accordance with print data corresponding to a print job. For example, print unit 418 can include a conventional laser printing mechanism that selectively causes toner to be applied to an intermediate surface of a drum or belt. The intermediate surface can then be brought within close proximity of a print media in a manner that causes the toner to be transferred to the print media in a controlled fashion. The toner on the print media can then be more permanently fixed to the print media, for example, by selectively applying thermal energy to the toner.

Print unit 418 can also be configured to support duplex printing, for example, by selectively flipping or turning the print media as required to print on both sides. Those skilled in the art will recognize that there are many different types of print units available, and that for the purposes of the present invention, print unit 418 can include any of these different types.

Printer 400 also includes a user interface and menu browser 420, and a display panel 422. The user interface and menu browser 420 allows a user of the printer 400 to navigate the printer's menu structure. User interface 420 can be indicators or a series of buttons, switches, or other selectable controls that are manipulated by a user of the printer. Display panel 422 is a graphical display that provides information regarding the status of the printer 400 and the current options available to a user through the menu structure.

Printer 400 can, and typically does include application components 424 that provide a runtime environment in which software applications or applets can run or execute. One exemplary runtime environment is a Java Virtual Machine (JVM). Those skilled in the art will recognize that there are many different types of runtime environments available. A runtime environment facilitates the extensibility of printer 400 by allowing various interfaces to be defined that, in turn, allow the application components 424 to interact with the printer.

1. A print media handling device comprising:
a stationary print media output collection tray having two opposing sides;
a print media biasing mechanism configured to bias print media of successively outputted print jobs towards alternatively opposite sides of the tray, thereby physically offsetting the print media of a print job from other print jobs.

2. A print media handling device as recited in claim 1, wherein the mechanism is further configured to collect the print media of a print job in a stack, thereby physically offsetting the stack of a print job from the other stacks.

3. A print media handling device as recited in claim 1, wherein the mechanism comprises at least two opposing, movable wings configured to suspend at least one edge of a print medium upon output.

4. A print media handling device as recited in claim 1, wherein the mechanism comprises at least two opposing, independently controlled, movable wings configured to suspend at least one edge of a print medium upon output.

5. A print media handling device as recited in claim 1, wherein the mechanism comprises at least two opposing, independently controlled, movable wings configured to selectively bias one edge of a print medium towards one side or the other of the tray.

6. A print media handling device comprising:
a stationary print media output collection tray;
a print media biasing mechanism configured to position into the tray print media of successively outputted print jobs into stacks that are physically offset from each other.

7. A print media handling device as recited in claim 6, wherein:
the tray has two opposing sides;
the mechanism is further configured to bias the print media of a print job towards one side of the tray and bias the print media of an immediately subsequent print job towards the opposite side of the tray.

8. A print media handling device as recited in claim 6, wherein the mechanism comprises at least two opposing, movable wings configured to suspend at least one edge of a print medium upon output.

9. A print media handling device as recited in claim 6, wherein the mechanism comprises at least two opposing, independently controlled, movable wings configured to suspend at least one edge of a print medium upon output.

10. A print media handling device as recited in claim 6, wherein:
the tray has two opposing sides;
the mechanism comprises at least two opposing, independently controlled, movable wings configured to selectively bias one edge of a print medium towards one side or the other of the tray.

11. A printer comprising:
a stationary print media output collection tray;
a print media biasing mechanism configured to position into the tray print media of successively outputted print jobs into stacks that are physically offset from each other.

12. A printer as recited in claim 11, wherein:
the tray has two opposing sides;
the mechanism is further configured to bias the print media of a print job towards one side of the tray and bias the print media of an immediately subsequent print job towards the opposite side of the tray.

13. A printer as recited in claim 11, wherein the mechanism comprises at least two opposing, movable wings configured to suspend at least one edge of a print medium upon output.

14. A printer as recited in claim 11, wherein the mechanism comprises at least two opposing, independently controlled, movable wings configured to suspend at least one edge of a print medium upon output.

15. A printer as recited in claim 11, wherein:
the tray has two opposing sides;
the mechanism comprises at least two opposing, independently controlled, movable wings configured to selectively bias one edge of a print medium towards one side or the other of the tray.

16. A method for facilitating print media handling, the method comprising:
receiving an indication of a print job;
biasing print media of the print job into a stack biased to one side of an output collection tray;
acquiring an indication of a next print job;
biasing print media of the next print job into another stack biased to a side of an output collection tray that is opposite of the side that the immediately previous print job was biased.

17. A method as recited in claim 16 further comprising repeating the acquiring and the biasing of print media of the next print job for subsequent print jobs
